(19) United States
(12) Patent Application Publication
(10) Pub. No.: US 2006/0259632 A1
(43) Pub. Date: Nov. 16, 2006

(54) REDIRECTION AND INVITATION FOR ACCESSING AN ONLINE SERVICE

(75) Inventors: Lee Crawford, Los Altos, CA (US); Albert So, San Jose, CA (US)

Correspondence Address: DARBY & DARBY P.C., P.O. BOX 5257, NEW YORK, NY, 10150-6257, US

(73) Assignee: Yahoo! Inc., Sunnyvale, CA (US)

(21) Appl. No.: 11/383,179

(22) Filed: May 12, 2006

Related U.S. Application Data
(60) Provisional application No. 60/680,700, filed on May 13, 2005.

(51) Int. Cl. G06F 15/16

(52) U.S. Cl. 709/229

(57) ABSTRACT

A system and method are directed towards enabling a user to access an online service such as an online multiplayer game. The online service notifies a message service, such as a portal service, that a first client is interacting with the online service. The message may include a network address to which the first client is connected, or the network address may be obtained separately. The message may also identify a second client, which the first client wishes to invite to participate in the online service. The second client can also be identified by the message service with a contact list. The message service may determine a current presence of the second client to determine a device and format currently being used by the second client. The message service provides the second client with a link to the network address and/or a redirection link to the online service.

### CROSS-REFERENCE TO RELATED APPLICATIONS

This application claims the benefit of U.S. Provisional Application, titled “Redirection and Invitation for Accessing an Online Service,” Ser. No. 60/680,700 filed on May 13, 2005, the benefit of the earlier filing date of which is hereby claimed under 35 U.S.C. §119(e), and further is incorporated by reference.

### FIELD OF THE INVENTION

The present invention relates generally to multi-person online services, and more particularly, but not exclusively, to enabling a client user to access the online service through an indication from another client that is participating in the online service.

### BACKGROUND OF THE INVENTION

Online multiplayer games and other collaboration services have become increasingly popular as network communications have improved. Users who may be geographically distant from each other may communicate with an online service to participate together in games and/or other collaboration services. Typically, users run a client program that performs local processing and communicates with the online service to coordinate joint state of the multi-user game or service. For users to initiate participation in the same online game or online service, users may meet in an online lobby or other matching system that is associated with the online game or online service. However, if a person is not already communicating with the same lobby, or already participating in the same online service, the person may not be aware that a friend or colleague is participating. The friend or colleague can manually telephone the person or send a message with an identifier to invite the person to participate in the same online game or service. To reach people outside of the online game service, a message is typically sent through an independent messaging service, such as an online portal email service or instant message service, which is generally not limited to registered users of the online game service. However, this out-of-band messaging may be time consuming to find contact information and may distract from a current game session or other service session.

The other users that are contacted may not have the client program needed to participate in the online service, or may not know how to access the particular game server on which the first user is participating. In that case, the other users typically access the online service independently to obtain the client program, and may attempt to search for the first user or use the out-of-band communication to obtain address information from the first user, a friend, or a colleague to join the same online session.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 shows a functional block diagram illustrating one embodiment of an environment for practicing the invention;

FIG. 2 shows one embodiment of a client mobile device that may be included in a system implementing the invention;

FIG. 3 shows one embodiment of a server that may be included in a system implementing the invention;

FIG. 4 illustrates one embodiment of an architecture for implementing the present invention;

FIG. 5 is a flow diagram illustrating exemplary logic for one embodiment of a server to provide an invitation message to a second client; and

FIG. 6 is a flow diagram illustrating exemplary logic of a second client device for accessing the client game program (or other client service) and interacting with the online game (or other online service).

### DETAILED DESCRIPTION OF THE INVENTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely software embodiment, an entirely hardware embodiment or an embodiment combining software and hardware aspects. The following detailed description is, therefore, not to be taken in a limiting sense. Briefly stated, the present invention is directed towards inviting a user to participate in an online service and directing the user to the online service. Although the invention is not so limited, an exemplary embodiment is described below in terms of a client executing a game program to participate in an online game system, and informing other clients through an instant message system that may or may not be directly associated with the online game system.

Illustrative Operating Environment

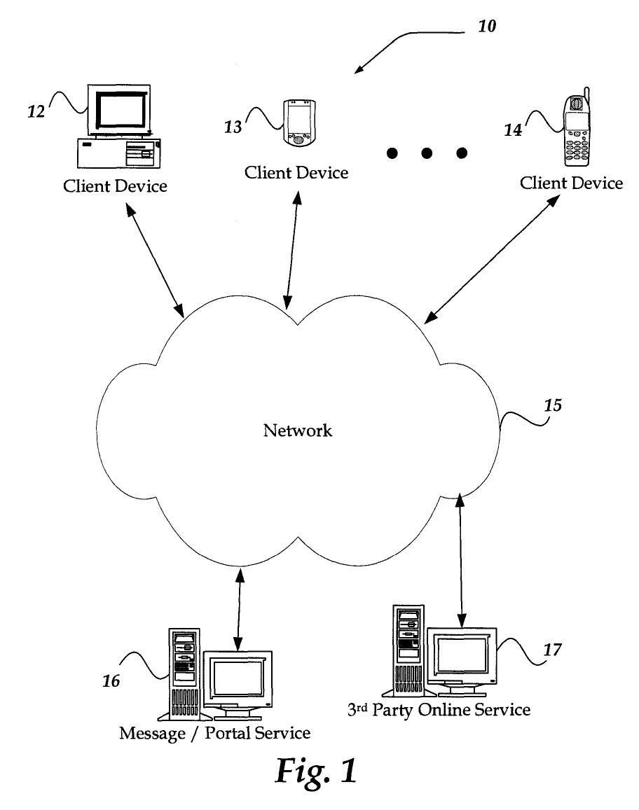

FIG. 1 illustrates one embodiment of an environment in which the present invention may operate. However, not all of these components may be required to practice the invention, and variations in the arrangement and type of the components may be made without departing from the spirit or scope of the invention.

As shown in the figure, a system 10 includes client devices 12-14, a network 15, a message service 16 that may also include other portal services, and a third party game service 17 that is not directly associated with the message service. Network 15 is in communication with and enables communication between each of client devices 12-14, message service 16, and game service 17.

Client devices 12-14 may include virtually any computing device capable of receiving and sending a message over a network, such as network 15, to and from another computing device, such as portal service 16, each other, and the like. The set of such devices may include mobile terminals that are usually considered more specialized devices and typically connect using a wireless communications medium such as cell phones, smart phones, pagers, walkie talkies, radio frequency (RF) devices, infrared (IR) devices, CBs, integrated devices combining one or more of the preceding devices, or virtually any mobile device, and the like. The set of such devices may also include devices that are usually considered more general purpose devices and typically connect using a wired communications medium such as personal computers, multiprocessor systems, microprocessor-based or programmable consumer electronics, network PCs, and the like. Similarly, client devices 12-14 may be any device that is capable of connecting using a wired or wireless communication medium such as a personal digital assistant (PDA), POCKET PC, wearable computer, and any other device that is equipped to communicate over a wired and/or wireless communication medium.

Each client device within client devices 12-14 includes a user interface that enables a user to control settings, such as presence settings, and to instruct the client device to perform operations. Each client device also includes a communication interface that enables the client device to send and receive messages from another computing device employing the same or a different communication mode, including, but not limited to instant messaging (IM), email, short message service (SMS) messaging, multi-media message service (MMS) messaging, internet relay chat (IRC), Mardam-Bey's internet relay chat (mIRC), Jabber, and the like. Client devices 12-14 may be further configured with a browser application that is configured to receive and to send web pages, web-based messages, and the like. The browser application may be configured to receive and display graphics, text, multimedia, and the like, employing virtually any web based language, including, but not limited to Standard Generalized Markup Language (SGML), HyperText Markup Language (HTML), Extensible Markup Language (XML), a wireless application protocol (WAP), a Handheld Device Markup Language (HDML), such as Wireless Markup Language (WML), WMLScript, JavaScript, and the like.

Network 15 is configured to couple one computing device to another computing device to enable them to communicate. Network 15 is enabled to employ any form of medium for communicating information from one electronic device to another. Also, network 15 may include a wireless interface, such as a cellular network interface, and/or a wired interface, such as an Internet interface, in addition to an interface to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize cellular telephone signals over air, analog telephone lines, full or fractional dedicated digital lines including T1, T2, T3, and T4, Integrated Services Digital Networks (ISDNs), Digital Subscriber Lines (DSLs), wireless links including satellite links, or other communications links that are equivalent and/or known to those skilled in the art. Furthermore, remote computers and other related electronic devices could be remotely connected to either LANs or WANs via a modem and temporary telephone link. In essence, network 15 includes any communication method by which information may travel between client devices 12-14, message service 16, and/or game service 17. Network 15 is constructed for use with various communication protocols including transmission control protocol/internet protocol (TCP/IP), WAP, code division multiple access (CDMA), global system for mobile communications (GSM), and the like.

The media used to transmit information in communication links as described above generally includes any media that can be accessed by a computing device. Computer-readable media may include computer storage media, wired and wireless communication media, or any combination thereof. Additionally, computer-readable media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wireless media such as acoustic, RF, infrared, and other wireless media, and wired media such as twisted pair, coaxial cable, fiber optics, wave guides, and other wired media.

Illustrative Client Environment

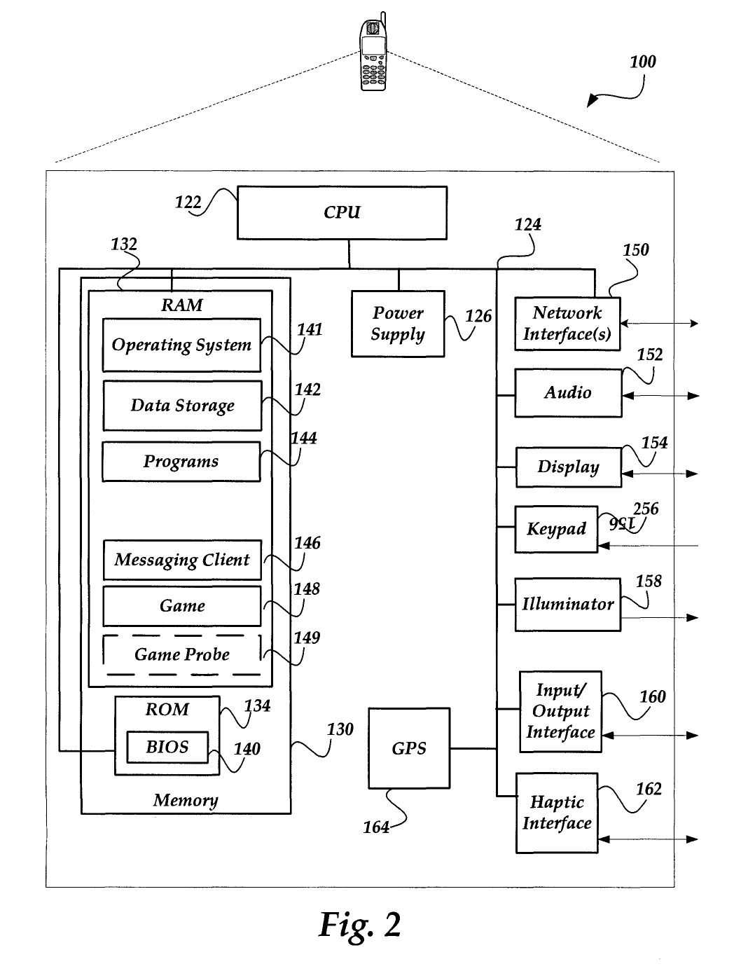

FIG. 2 shows one embodiment of client device 100 that may be included in a system implementing the invention. Client device 100 may include many more or less components than those shown in FIG. 2. However, the components shown are sufficient to disclose an illustrative embodiment for practicing the present invention. In this sample embodiment, client device 100 is generally configured as a mobile terminal. However, a general purpose computing device or other client device may be used. Such other devices may include other components not shown such as a hard disk drive, a removable media drive, and/or other components generally associated with such client devices. As shown in the figure, client device 100 includes a processing unit 122 in communication with a mass memory 130 via a bus 124.

Client device 100 also includes a power supply 126, one or more network interfaces 150, an audio interface 152, a display 154, a keypad 156, an illuminator 158, an input/output interface 160, a haptic interface 162, and an optional global positioning systems (GPS) receiver 164. Power supply 126 provides power to client device 100. A rechargeable or non-rechargeable battery may be used to provide power. The power may also be provided by an external power source, such as an AC adapter or a powered docking cradle that supplements and/or recharges a battery.

Client device 100 may optionally communicate with a base station (not shown), or directly with another computing device. Network interface 150 includes circuitry for coupling client device 100 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, and the like.

Audio interface 152 is arranged to produce and receive audio signals such as the sound of a human voice. For example, audio interface 152 may be coupled to a speaker and microphone (not shown) to enable telecommunication with others and/or generate an audio acknowledgement for some action. Display 154 may be a liquid crystal display (LCD), gas plasma, light emitting diode (LED), or any other type of display used with a computing device. Display 154 may also include a touch sensitive screen arranged to receive input from an object such as a stylus or a digit from a human hand.

Keypad 156 may comprise any input device arranged to receive input from a user. For example, keypad 156 may include a push button numeric dial, or a keyboard. Keypad 156 may also include buttons for inputting commands such as cursor movements, menu selections, instructions associated with selecting and sending images, and the like. Illuminator 158 may provide a status indication and/or provide light. Illuminator 158 may remain active for specific periods of time or in response to events. For example, when illuminator 158 is active, it may backlight the buttons on keypad 156 and stay on while the client device is powered. Also, illuminator 158 may backlight these buttons in various patterns when particular actions are performed, such as dialing another client device. Illuminator 158 may also cause light sources positioned within a transparent or translucent case of the client device to illuminate in response to actions.

Client device 100 also comprises input/output interface 160 for communicating with external devices, such as a headset, an external keyboard, or other input or output devices not shown in FIG. 2. Input/output interface 160 can utilize one or more communication technologies, such as USB, infrared, Bluetooth™, and the like. Haptic interface 162 is arranged to provide tactile feedback to a user of the client device. For example, the haptic interface may be employed to vibrate client device 100 in a particular way when another user of a computing device is calling.

Optional GPS transceiver 164 can determine the physical coordinates of client device 100 on the surface of the Earth, which typically outputs a location as latitude and longitude values. GPS transceiver 164 can also employ other geo-positioning mechanisms, including, but not limited to, triangulation, assisted GPS (AGPS), E-OTD, CI, SAI, ETA, BSS and the like, to further determine the physical location of client device 100 on the surface of the Earth. It is understood that under different conditions, GPS transceiver 164 can determine a physical location within millimeters for client device 100; and in other cases, the determined physical location may be less precise, such as within a meter or significantly greater distances.

Mass memory 130 includes a RAM 132, a ROM 134, and other storage means. Mass memory 130 illustrates another example of computer storage media for storage of information such as computer readable instructions, data structures, program modules or other data. Mass memory 130 stores a basic input/output system (“BIOS”) 140 for controlling low-level operation of client device 100. The mass memory also stores an operating system 141 for controlling the operation of client device 100. It will be appreciated that this component may include a specialized client communication operating system such as Windows Mobile™, or the Symbian ® operating system, or a general purpose operating system such as a version of UNIX, LINUX™, Window®, or the like. The operating system may include, or interface with a virtual machine module, such as a Java™ virtual machine module that enables control of hardware components and/or operating system operations via Java application programs.

Memory 130 further includes one or more data storage 142, which can be utilized by client device 100 to store, among other things, programs 144 and/or other data. For example, data storage 142 may also be employed to store information that describes various capabilities of client device 100. The information may then be provided to another device based on any of a variety of events, including being sent as part of a header during a communication, sent upon request, and the like.

Programs 144 may include computer executable instructions which, when executed by client device 100, process text, audio, video, and the like. Other examples of application programs include calendars, contact managers, task managers, transcoders, database programs, word processing programs, spreadsheet programs, games, codec programs, and so forth. In addition, mass memory 130 stores a messaging client 146, to transmit, receive, and/or otherwise process messages (e.g., SMS, MMS, IM, email, and/or other messages), and enable telecommunication with a server, another user of another client device, and the like. Mass memory 130 may further include a game client 148, providing game execution instructions on client device 100, and/or game communication services with an online game. Optionally, a game probe 149 may also be included for detecting and/or monitoring game programs on client device 100.

Exemplary Message/Portal Server

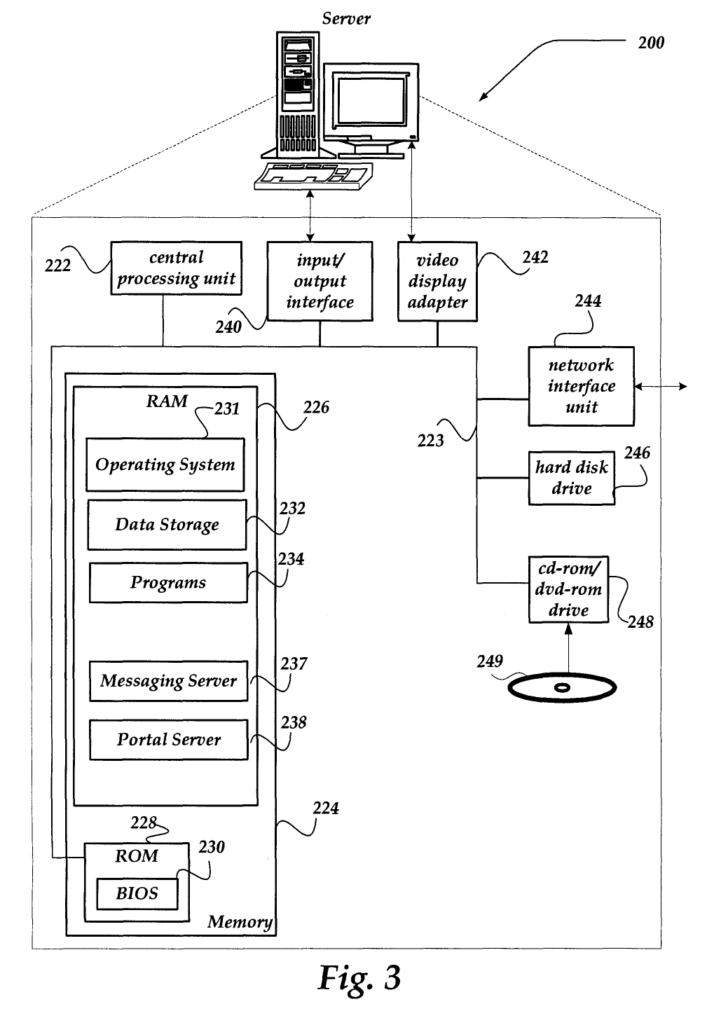

One embodiment of an exemplary message server, such as a server device 200, is described in more detail below in conjunction with FIG. 3. Briefly, message server device 200 may include any computing device capable of connecting to network 15 to enable a user to communicate with other devices, such as game service 17, and/or other devices. Message server device 200 may or may not be combined with, in communication with, or otherwise associated with portal services, such as news services, financial services, messaging services, search services, and the like. Message server device 200 may include many more components than those shown. The components shown, however, are sufficient to disclose an illustrative embodiment for practicing the invention. Many of the components of message server device 200 may also be duplicated in a server of a portal service, a server of game service 17, and/or other server devices.

As shown in the figure, message server device 200 includes a processing unit 222 in communication with a mass memory 224 via a bus 223. Mass memory 224 generally includes a RAM 226, a ROM 228, and other storage means. Mass memory 224 also illustrates a type of computer-readable media, namely computer storage media. Computer storage media may include volatile and nonvolatile, removable and non-removable media implemented in any method or technology for storage of information such as computer readable instructions, data structures, program modules or other data. Other examples of computer storage media include EEPROM, flash memory or other semiconductor memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

Mass memory 224 stores a basic input/output system (“BIOS”) 230 for controlling low-level operation of message server device 200. The mass memory also stores an operating system 231 for controlling the operation of message server device 200. It will be appreciated that this component may include a general purpose operating system such as a version of Windows™, UNIX, LINUX™, or the like. The operating system may also include, or interface with a virtual machine module that enables control of hardware components and/or operating system operations via application programs.

Mass memory 224 further includes one or more data storage units 232, which can be utilized by message server device 200 to store, among other things, programs 234 and/or other data. Programs 234 may include computer executable instructions which can be executed by message server device 200 to implement a WAP, HTTP, or other protocol handler application for transmitting, receiving and otherwise processing communications. Similarly, programs 234 can include a WAPS, HTTPS, or other protocol handler application for handling secure connections, such as initiating communication with an external application in a secure fashion. Other examples of application programs include schedulers, calendars, web services, transcoders, database programs, word processing programs, spreadsheet programs, and so forth. Accordingly, programs 234 can process data communications, web pages, audio, video, and enable telecommunication with electronic devices.

In addition, mass memory 224 may store one or more programs for messaging, gaming and/or other applications. A messaging server module 237 may include computer executable instructions, which may be run under control of operating system 231 to enable SMS, MMS, instant messaging, e-mail, and/or other messaging services. Similarly, message server device 200 may provide routing, access control, and/or other server-side messaging services. Message server device 200 may further include a portal server 38, which provides other portal services, including shopping services, social networking services, mapping services, and the like. A server device configured much like message server device 200 (and/or message server device 200 itself) may include a monitoring module (not shown) that monitors activity of online game services. The same server, or a different server may include or communicate with a data warehouse module (not shown) that collects, analyzes, and stores aggregated information regarding the online game services.

Message server device 200 also includes an input/output interface 240 for communicating with input/output devices such as a keyboard, mouse, wheel, joy stick, rocker switches, keypad, printer, scanner, and/or other input devices not specifically shown in FIG. 3. A user of message server device 200 can use input/output devices to interact with a user interface that may be separate or integrated with operating system 231 and/or programs 234-238. Interaction with the user interface includes visual interaction via a display, and a video display adapter 242.

Message server device 200 may include a removable media drive 244 and/or a permanent media drive 246 for computer-readable storage media. Removable media drive 244 can comprise one or more of an optical disc drive, a floppy disk drive, and/or a tape drive. Permanent or removable storage media may include volatile, nonvolatile, removable, and non-removable media implemented in any method or technology for storage of information, such as computer readable instructions, data structures, program modules, or other data. Examples of computer storage media include a CD-ROM 249, digital versatile disks (DVD) or other optical storage, magnetic cassettes, magnetic tape, magnetic disk storage or other magnetic storage devices, RAM, ROM, EEPROM, flash memory or other memory technology, or any other medium which can be used to store the desired information and which can be accessed by a computing device.

Via a network communication interface unit 244, message server device 200 can communicate with a wide area network such as the Internet, a local area network, a wired telephone network, a cellular telephone network, and/or some other communications network, such as network 15 in FIG. 1. Network communication interface unit 244 is sometimes known as a transceiver, transceiving device, network interface card (NIC), and the like.

Exemplary Invitation and Rediraction

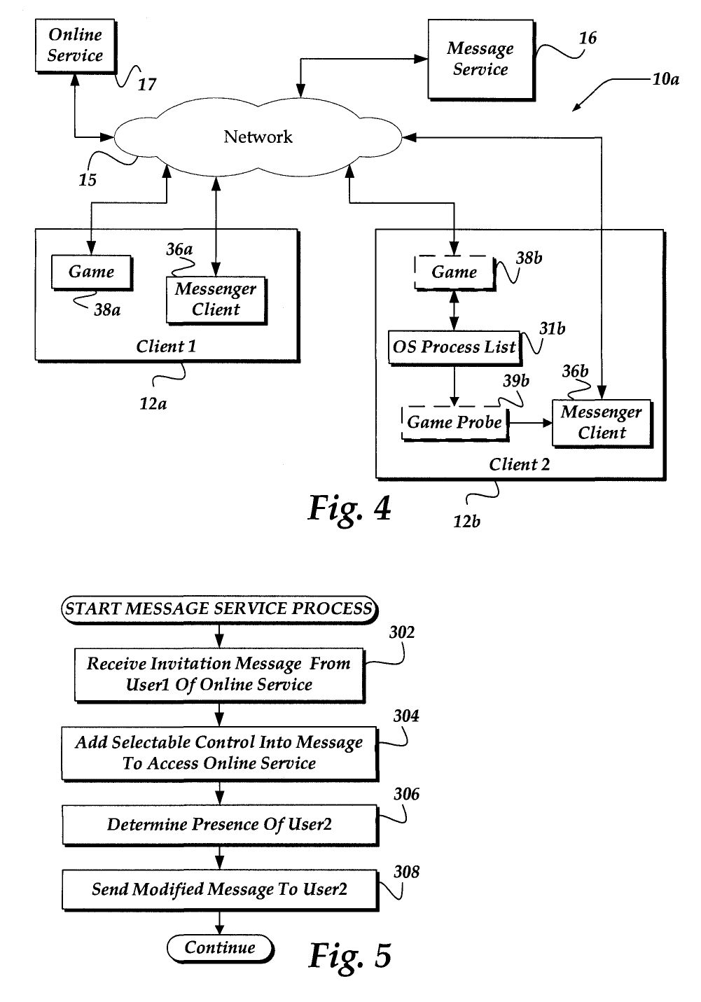

FIG. 4 illustrates one embodiment of an architecture 10a for practicing the present invention. However, not all of the illustrated modules may be required to practice the invention, and variations in the arrangement and type of the components may be made without departing from the spirit or scope of the invention.

As shown in the figure, a sample first client 12a includes a game 38a that may communicate through network 15 and interface with game service 17 to participate in an online, multiplayer game. Clients need not include a local game program, but may use a general purpose browser and/or other means to communicate with the game service. Game service 17 may include a game messaging service that can be used for communication among registered users of the game service. First client 12a may access the game messaging service through game 38a. In addition, or alternatively, game service 17 may communicate with a separate message service 16, which may include a portal service, to provide messaging services and/or route messages to registered users of game service 17 and/or to other clients that are not associated with game service 17. Message routing may be fixed through message service 16. Alternatively, a user of first client 12a may choose whether to send a message via the messaging service of game service 17 or via message service 16. The user of first client 12a may also choose to use a separate messenger client 36a that communicates through message service 16.

The user of first client 12a may wish to invite a user of second client 12b to participate in game service 17. If the user of first client 12a knows the network address of the game server to which fist client 12a is connected, messenger client 36a can be used to relay the network address. However, the user of first client 12a may not know how to provide the user of second client 12b with the proper network address, so that second client 12b could connect to the same server as first client 12a. Game service 17 may provide the network address, and the user of first client 12a may send the network address in a message using messenger client 36a. Alternatively, game service 17 may provide the network address to message service 16, along with a user identification (ID) of first client 12a. Message service 16 may then relay the network address to second client 12b in a message, such as an instant message. Message service 16 may also send a message to other users that are associated with first client 12a. For example, message service 16 may store an address book associated with first client 12a, and may distribute a message to each entry in the address book, inviting other users to participate in the same game with first client 12a. Alternatively, first client 12a may provide game service 17 with contact information or a user ID for second client 12b. Game service 17 may relay the contact information or user ID to message service 16, along with the network address of the game server to which first client 12a is connected. Message service 16 may send an invitation message with a link for the appropriate network address to second client 12b.

If a user of second client 12b selects the link in the message, a script or other module may check whether second client 12b includes a game client program, such as game 38b, which might be needed for interaction with game service 17. If second client 12b already has the needed game client program, second client 12b may use the network address relayed in the message to contact the same game server as first client 12a. If second client 12b does not already have a needed game client, second client 12b may be redirected to another portion of game service 17 to download the needed game program.

Second client 12b may also download an optional game probe 39b to detect execution of one or more predefined game files through an operating system process list 31b. The game probe may automatically notify other clients via a messenger client 38b. Game service 17, a games monitoring service, a portal service, and/or other online services may determine which online games and/or other programs are available. For example, a games monitor or portal may monitor a changing status of games and/or other programs available through network 15. An example of a games monitor (not shown) is an All Seeing Eye™ (ASE) server that detects new games, monitors loading on numerous games servers, matches clients for play, and performs other services. In particular, the games monitor may provide executable process names and status information through network 15 to message service 16, a portal service, and/or to clients. The games monitor may provide information services related to a wide variety of games and games providers. Accordingly, the games monitor may comprise a collection of monitors that may or may not be directly associated with particular games and/or game services.

If second client 12b executes game 38b as an application program process, the corresponding process name is listed in operating system process list 31b. An optional game probe 39b monitors operating system process list 31b to detect when game 38b and/or other predetermined programs are executing. When game probe 39b detects executing game 38b, the game probe instructs a messenger client 36b to inform message service 16 that second client 12b is participating in the online game. The game probe also instructs the messenger client to request that message service 16 notify other clients that second client 12b is participating in the online game. The other clients are generally members of a contact list associated with second client 12b. The contact list may comprise contacts in an instant messenger list, an email address book, and/or other collections of communication contacts. Second client 12b and/or message service 16 may store the contact list. Some contacts may be obtained from game service 17, however the contact list is not limited to members of game service 17. Message service 16 is also generally independent of game service 17, which might be limited to a single game, or a small subset of programs. Although message service 16 may comprise a portal that includes one or more game services, message service 16 need not be directly related to, or controlled by game service 17. Instead, message service 16 may act as an intermediary between a wide variety of game services, enabling clients to interact beyond the boundaries of an particular game service.

For example, message service 16 can communicate the notification through network 15 to a another messenger client of a third client device (not shown), who may, or may not be a current member of game service 17. The notification can be displayed and/or otherwise provided to a user of the third client, who may choose to download and/or execute the game program and participate in the online multiplayer game with the user of first client 12a. If the user of the third client executes the game, the corresponding process name will be added to an operating system process list of the third client device. If the third client includes a game probe, it can instruct the messenger client to notify other client devices that the third client is also participating in the online multiplayer game.

FIG. 5 is a flow diagram illustrating exemplary logic for one embodiment of a message service to provide a message with a link that can direct a second client to an online service at which a first client is participating, such as an online game service. The message service may include portal services. At an operation 302, the message service receives an invitation message, indicating that a first user of an online service wishes to invite a second user to participate in the same online service. The invitation message may come from a messaging service of the online service, from a messenger client of the first user device, from a portal service with which the first user and/or the online service communicates, or the like. The invitation message generally includes an identifier of the first user. The invitation message may also include an identifier of the second user, or may indicate that the first user wishes the invitation message to be distributed to a number of other users that are associated with the first user via an address book or other contact list. The invitation message, or a separate message, may further include a network address through which the first user is communicating with the online service. The network address may be provided by the online service, by the first user, by the portal, or by another source. If the invitation message does not include the network address, the message service adds a link into the invitation message, at an operation 304. The link may lead directly to the network address, or to another source through which the second user could access the online service.

At an operation 306, the message service may determine a presence of the second user. The presence indicates whether the second user is currently available to receive a message, which client device the second user may be using, and/or other information about the second user. Based on the presence information, the message service sends the modified invitation message to the second user, including the link for accessing the online service.

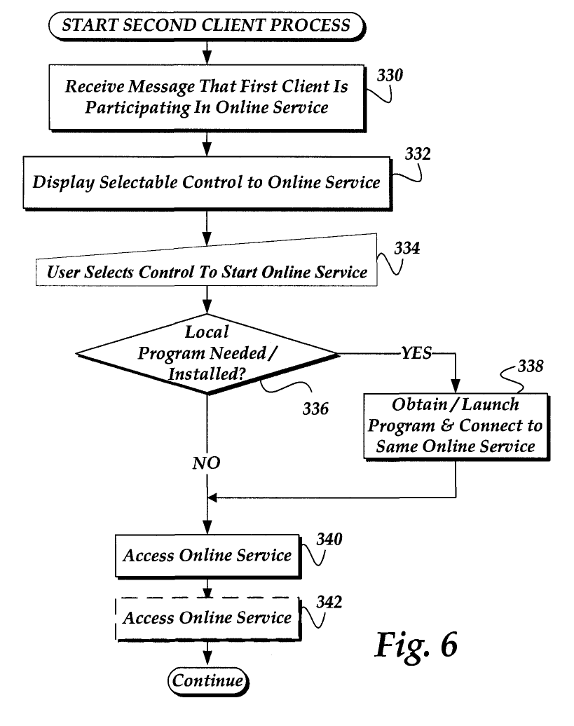

FIG. 6 is a flow diagram illustrating exemplary logic of a second client device for accessing a client program (such as a client game program) and interacting with the online service (such as an online game service). At an operation 330, the second client device receives the invitation message that the first client device is engaged in the online service. The message includes a link or other address information needed for the second client device to communicate with the same online service, or to otherwise access the online service. The message may come as an instant message, as an email message, as an SMS message, or other type of message. Alternatively, the message may come in the form of a presence indication through a local messaging service, such as a local instant message service, running on second client device. For example, the messaging service may provide an audio tone and/or a visual icon indicating that the first client is online. The received message, the audio tone, and/or visual icon may also include a link or other identifier of the online service with which the first client is interacting. The identifier is displayed at an operation 332 with a selectable control (e.g., a button, text, a hyper link, etc.) that enables the second user to initiate the service in which the first client is participating, such as a game. At an operation 334, the user selects the control to initiate the service, such as the game.

At a decision operation 336, the local messaging service, a downloaded script, or other program of the second client determines whether a needed program is installed on the second client device (e.g. a needed game program). If the program is needed and is already installed on the second client device, the second client device launches the program at an operation 138. If the program is needed, but not yet installed on the second client, the second client device may be directed to a network location to obtain the needed program, either automatically or with the second user's consent. The second user may choose to temporarily try, rent, or permanently buy the needed program or subscription to the online service. The needed program or other local client service (e.g., a browser) may then use the address information to connect to the same online service as the first client, at an operation 340. As discussed above, the second client may also use a local client probe, at an operation 342, to detect execution of the needed program and invite other users to join the second user in the online service.

The above specification, examples, and data provide a complete description of the manufacture and use of the composition of the invention. However other embodiments will be clear to one skilled in the art. Since many embodiments of the invention can be made without departing from the spirit and scope of the invention, the invention resides in the claims hereinafter appended.

What is claimed as new and desired to be protected by Letters Patent of the United States is:

1. A method for enabling a user to access an online service, comprising:
receiving from the online service, an indication that a first client is interacting with the online service;
receiving from the online service, a network address of a network device to which the first client is connected for interacting with the online service; and
sending to a second client, a message including a selectable interface control for accessing the online service at the network address.

2. The method of claim 1, further comprising determining the second client based on an identifier of the first client.

3. The method of claim 1, further comprising receiving from the online service, an identifier of the second client.

4. The method of claim 1, wherein the first client causes the online service to send the indication that the first client is interacting with the online service.

5. The method of claim 1, wherein the message comprises at least one of the following; an instant message, a short message service message, and an email.

6. The method of claim 1, wherein the online service comprises a multiplayer game.

7. The method of claim 1, wherein at least one of the first client and the second client comprises a mobile terminal.

8. The method of claim 1, further comprising:
determining a presence of the second client, including determining a type of client device currently used by the second client; and
generating the message to conform with a format of the client device.

9. The method of claim 1, wherein the selectable interface control comprises at least one of the following; a hyper link and a selectable graphic.

10. A computer readable medium, comprising executable instructions for performing actions, including:
receiving from the online service, an indication that a first client is interacting with the online service;
receiving from the online service, a network address of a network device to which the first client is connected for interacting with the online service; and
sending to a second client, a message including a selectable interface control for accessing the online service at the network address.

11. A modulated data signal for communicating data over a network, the modulated data signal comprising instructions that enable a computing device to perform the actions of:
receiving from the online service, an indication that a first client is interacting with the online service;
receiving from the online service, a network address of a network device to which the first client is connected for interacting with the online service; and
sending to a second client, a message including a selectable interface control for accessing the online service at the network address.

12. A server device for enabling a user to access an online service, comprising:
a communication interface in communication with the online service and a second client;
a memory for storing instructions and data; and
a processor in communication with the communication interface and with the memory, wherein the processor performs actions based at least in part on the stored instructions, including:
receiving from the online service, an indication that a first client is interacting with the online service;
receiving from the online service, a network address of a network device to which the first client is connected for interacting with the online service; and
sending to the second client, a message including a selectable interface control for accessing the online service at the network address.

13. The client device of claim 12, wherein the processor further performs the action of determining the second client based on an identifier of the first client.

14. The server device of claim 12, wherein the processor further performs the action of accessing comprises the actions of receiving from the online service, an identifier of the second client.

15. The server device of claim 12, wherein the first client causes the online service to send the indication that the first client is interacting with the online service.

16. The client device of claim 12, wherein the message comprises at least one of the following; an instant message, a short message service message, and an email.

17. The client device of claim 12, wherein the online service comprises a multiplayer game.

18. The client device of claim 12, wherein the processor further performs the actions of:
determining a presence of the second client, including determining a type of client device currently used by the second client; and
generating the message to conform with a format of the client device.

19. A client device for enabling a user to access an online service, comprising:
a communication interface in communication with a message service that is in communication with an online service;
a memory for storing instructions and data; and
a processor in communication with the communication interface and with the memory, wherein the processor performs actions based at least in part on the stored instructions, including:
receiving from the message service, an indication that a first client is interacting with the online service;
receiving from the message service, a network address of a network device to which the first client is connected for interacting with the online service;
detecting selection of a selectable interface control; and
accessing the online service at the network address.

20. The client device of claim 19, wherein the processor further performs the actions of:
detecting that a predefined process is executing, wherein the predefined process causes the client device to interact with the online service;
requesting that the message service send a notification to another client that the client device is interacting with the online service, wherein the notification includes the network address.
